(19) United States
(12) Patent Application Publication
(10) Pub. No.: US 2011/0193971 A1
(43) Pub. Date: Aug. 11, 2011

(54) NETWORK CAMERA

(75) Inventor: TSUNG-MING LIN, Si Jhih City (TW)

(73) Assignee: A-TEC SUBSYSTEM INC., TAIPEI (TW)

(21) Appl. No.: 12/703,312

(22) Filed: Feb. 10, 2010

(51) Int. Cl. H04N 5/225

(52) U.S. Cl. 348/207.1; 348/E05.024

(57) ABSTRACT

A network camera with a network interface includes an image sensing unit for capturing image information, a digital image processing unit for converting and compressing the image information into a digital video signal, a serial data encoding unit for encoding the digital video signal to generate a data signal in compliance with an operating system software interface and a network control unit for converting the data signal into a serial network signal packet, such that a user can connect the network camera to a computer or an embedded system device having a network interface through a network bridge. Compared with a conventional network camera limited by the length of its USB cable, the innovative network camera can increase the distance of connecting the network camera and the computer significantly to improve the convenience and the scope of application.

### FIELD OF THE INVENTION

The present invention relates to a webcam, in particular to a network camera having a network interface for transmitting audio and video signals.

### BACKGROUND OF THE INVENTION

In general, a webcam digitizes a signal of an image detected by an image sensor to generate a video stream and transmits the video stream to a computer through a universal serial bus (USB) data transmission line, so that users can connect the webcam to a computer to view the image captured by the webcam, and a network application program installed in the computer is provided for transmitting the image captured by the webcam to another specific computer device.

In the aforementioned external webcam, the USB transmission line is connected to the computer, and some high-end notebook computers come with a webcam built in the computers. Regardless of a built-in webcam or an external webcam, there is a technical issue, since the distance of connecting the webcam with the computer is limited, and the webcam can be used for a single computer only. For example, a built-in webcam has a fixed viewing angle, so that users have to move the whole set of notebook computer to capture the images at different positions, and such application is very inconvenient. Even if an external webcam is adopted, the application is still restricted by the length of the USB transmission line. At present, the USB transmission line generally has a length of 5 meters. For applications requiring a transmission distance over 5 meters, the external webcam cannot be used anymore. Obviously, the disposing position and the application of the webcam constitute limitations of the webcam application.

To overcome the foregoing shortcomings of the prior art, related manufactures have provided a webcam known as an IP cam, which is a camera adopting the RJ-45 network interface and capable of viewing or recording an image at a remote end through a network or the Internet, and users at a remote end simply need to logon a network (or the Internet) and use a webpage browser to input an IP address of the IP-cam to view the image, and the IP cam can support various different network architectures such as ADSL, Internet, LAN and WLAN. Since the IP address is built in the IP cam, therefore the IP cam is applicable for executing surveillance and recording functions at a remote end through the network.

However, there are different functions of the IP cam, and it is necessary to integrate different high-end chips including an image compression chip, a network controller chip and a memory chip, etc, and thus the manufacturing cost is increased, and the selling price cannot be lowered to a level acceptable by consumers. Furthermore, the function and the related network knowledge required for installing the IP cam cannot meet the user requirements.

Therefore, it is a main subject for the present invention to disclose a webcam having a network interface for transmitting audio and video signals and meeting the user requirements, so as to overcome the shortcomings of the prior art including the inconvenience of the conventional webcam, and the high cost and the difficult installation of the IP cam.

### SUMMARY OF THE INVENTION

In view of the aforementioned shortcomings of the prior art, the inventor of the present invention based on years of experience in the related industry to conduct extensive researches and experiments, and finally developed a network camera to overcome the shortcomings of the prior art.

It is a primary objective of the present invention to provide a network camera having a network interface for transmitting audio and video signals, such that the audio and video signals can be compressed and encoded, and then a network communication protocol is used for transmitting the audio and video signal. The network cable and existing network facilities can be used for connecting a computer or a data processing device automatically, so as to overcome the shortcomings of the prior art including the inconvenient use of the conventional network camera or the high cost and the difficult installation of the IP cam.

To achieve the foregoing objectives, the present invention provides a network camera used in a local area network, and the network camera comprises: an image sensing unit, for capturing image information; a digital image processing unit, for converting and compressing the image information into digital video signal data; a serial data encoding unit, for encoding the digital video signal data to generate a serial video data signal stream compatible to an operating system interface standard; and a network control unit, for converting the serial video data signal stream into a serial network signal packet provided for a network transmission.

In a preferred embodiment of the present invention, the network camera further comprises an audio sensing unit, for capturing audio information; and a digital audio processing unit, for converting and compressing the audio information into digital audio signal data, wherein the serial data encoding unit encodes the digital video signal data and the digital audio signal data to generate a serial audio and video signal stream, such that the network control unit can convert the serial audio and video signal stream into a serial audio and video network signal packet provided for a network transmission.

The network camera of the present invention can convert digital audio and video data into audio and video data in compliance with a network packet specification, such that the network camera can transmit audio and video data through the network to improve the convenience of the application. Although the network camera of the present invention does not adopt the IP communication protocol of the IP cam, yet the network transmission capability is limited for the use in the Intranet only, so that the production cost of the network camera can be lowered significantly, and the installation is made much easier.

### BRIEF DESCRIPTION OF THE DRAWINGS

FIG. 1 is a schematic block diagram of a network camera of the present invention;

FIG. 2 is a schematic diagram of a network camera in accordance with a preferred embodiment of the present invention; and

FIG. 3 is a schematic view of a network camera applied in a corporate intranet in accordance with the present invention.

### DESCRIPTION OF THE PREFERRED EMBODIMENTS

To make it easier for the examiner to understand the objects, characteristics and effects of this invention, we use preferred embodiments together with the attached drawings for the detailed description of the invention as follows.

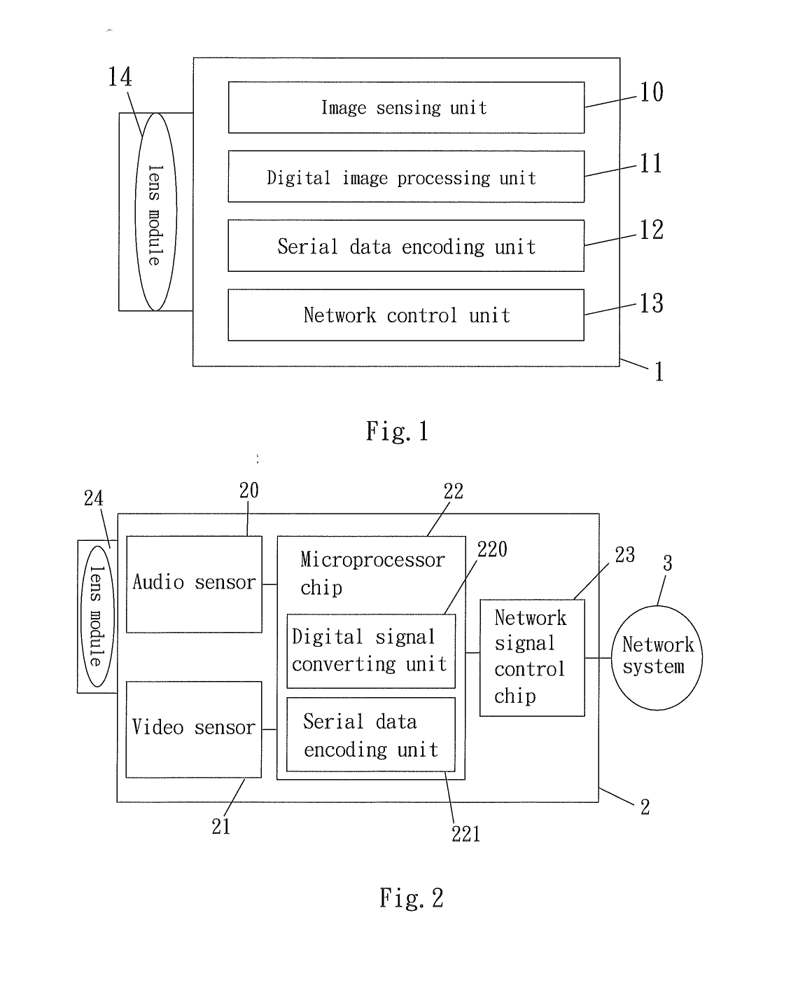

With reference to FIG. 1 for a schematic block diagram of a network camera of the present invention, the network camera 1 comprises the following elements:

An image sensing unit 10 is provided for capturing image information, wherein the image sensing unit is an image sensing chip such as a CMOS or CCD image sensing chip, and the image sensing chip can capture various different external images.

A digital image processing unit 11 is electrically coupled to the image sensing unit 10 and provided for converting and compressing image information captured by the image sensing unit 10 into a digital video signal, wherein the digital image processing unit 11 is a microprocessor chip having the function of converting analog and digital images, and the analog image information can be converted into a digital video signal, or a video signal can be compressed or converted into its transmission specification.

A serial data encoding unit 12 is electrically coupled to the digital image processing unit 11 and provided for encoding the digital video signal to generate a serial data signal stream in a standard format supported by the operating system, so that it is not necessary for peripherals to install a driver program in order to connect to a computer, and such arrangement improves the convenience of transmitting data. The serial data encoding unit 12 of the invention integrates a driver program set compatible to the data processing device into the serial data signal stream, so that no additional driver program is required to be installed to the network camera for connecting the network camera to the computer.

A network control unit 13 is provided for converting the serial data signal stream into a serial network signal packet. The network control unit 13 of the present invention is not a general network chip, but the chip must be compatible to a specific serial format (such as USB) capable of converting the data signal stream into the serial network signal packet in a network transmission format. In other words, the serial data signal stream can be converted into a packet form, and the signal stream of the network in the packet form can be transmitted to a computer at a user's end.

A lens module 14 having an optical mapping function is provided for the image sensing unit 10 to capture image information.

In a practical application in accordance with a preferred embodiment of the present invention, the image sensing unit 10 of the lens module 14 captures external image information, and the digital image processing unit 11 converts and compresses the image information into a digital video signal, and the serial data encoding unit 12 encodes the digital video signal to generate a serial video data signal stream, and finally the network control unit 13 converts the serial video data signal stream into a network signal in a packet form.

In a preferred embodiment of the present invention, the network camera further comprises an audio sensing unit for capturing audio information and a digital audio processing unit for converting and compressing the audio information into a digital audio signal, wherein the serial data encoding unit 12 encodes the digital video signal and the digital audio signal to generate a serial audio and video data signal stream, and the network control unit 13 converts the serial audio and video data signal stream into a video network signal stream in a packet form, such that when a computer at a user's end decodes the packet, users can obtain both video data and audio data at the network camera end.

In another preferred embodiment, the network control unit 13 can be connected to at least one data processing device through a cable network or a wireless network, wherein the data processing device is a computer, a mobile phone, a personal digital assistant (PDA) or any other device with data processing and network connection functions.

With reference to FIG. 2 for a schematic view of a network camera in accordance with a preferred embodiment of the present invention, the network camera 2 connected to a network system 3 comprises a video sensor 20, an audio sensor 21, a microprocessor chip 22, a network signal controller chip 23 and a lens module 24, wherein the microprocessor chip 22 further comprises a digital signal converting unit 220 and a serial data encoding unit 221.

The functions of the image sensor 20 and the audio sensor 21 for capturing image information and audio information are prior arts and will not be described here. In this preferred embodiment, a microprocessor chip 22 is provided for converting and compressing image information and audio information as well as encoding serial data. In FIG. 2, the microprocessor chip 22 includes a digital signal converting unit 220 and a serial data encoding unit 221, wherein the digital signal converting unit 220 is provided for converting the image information and the audio information into digital signals, and the serial data encoding unit 221 is provided for compressing and converting the digital signals, and integrating a driver program set compatible to a user's end computer to form a serial audio and video data signal stream, and then the network signal controller chip 23 converts the audio and video data signal into a network signal in a packet form.

With the aforementioned method, the computer at a user's end can be connected to the network camera 2 through the network system 3. For example, a RJ45 network cable is used for connecting the network camera 2, and a bridge such as a hub or a router can be used for improving the distance of collecting the network camera 2 and the computer. For example, a corporate intranet among several building can be connected without any difficulty.

In a preferred embodiment, the network signal controller chip 23 can be connected to at least one data processing device through a cable network or a wireless network, wherein the data processing device can be connected actively and provided for the network control unit to capture a network signal outputted from the network camera.

In another preferred embodiment, the serial data encoding unit 221 transmits the encoded data signal to a network signal controller chip 23 through a serial bus.

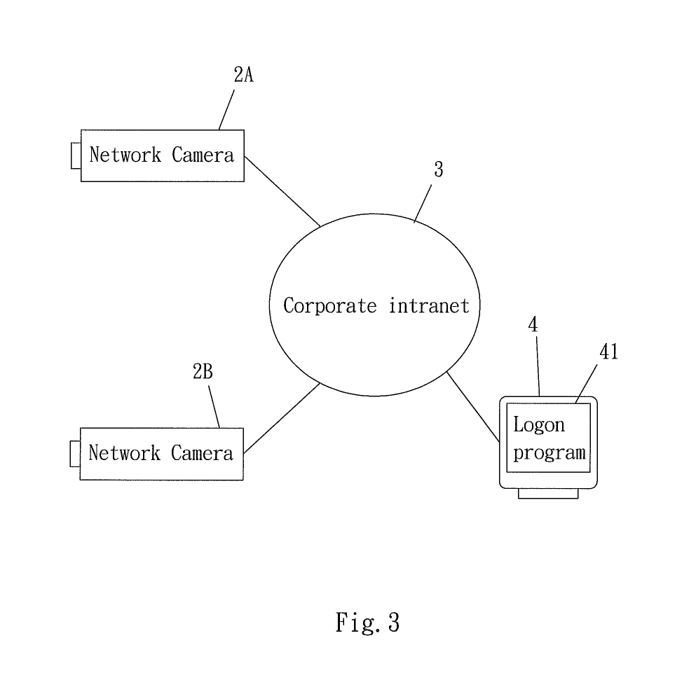

With reference to FIG. 3 for a schematic view of a network camera applied in a corporate intranet in accordance with the present invention, the network cameras 2A, 2B are connected to a personal computer 4 in a corporate intranet 3′, wherein the personal computer 4 includes an application program 41 (such as a logon program).

In a practical application, the personal computer 4 runs the application program 41, and the application program 41 automatically searches whether or not a network camera is connected to the corporate intranet 3′ (which can be a local area network), and the searched network cameras 2A, 2B are displayed on a software user operating interface, and the personal computer 4 is connected to a selected network camera through the corporate intranet 3′ to capture the audio and video data packet, and then the personal computer 4 decodes the audio and video data packet to obtain data, and finally the application program 41 executes the data and displays the video data and audio data captured at a remote end (which is at a network camera's end) through output devices (such as a display screen or a speaker) of the personal computer 4.

The network camera of the present invention adopts the method of converting signals in compliance with the aforementioned operating system standard serial format into network signals in a packet form, such that the video signal and the audio signal captured by the network camera can be transmitted to a computer device at a user's end through the network system, and the invention can improve the installation of the network camera and the convenience of using the network camera. In addition, the network camera of the present invention does not adopt the structure of a conventional IP cam, so that a high-price processing chip is not required, and the manufacturing cost of the network camera can be lowered.

In summation of the description above, the present invention the present invention integrates the serial encoding technology with the technology of converting the operating system standard serial signal specification into the network specification to lower the cost and improve the convenience of using the network camera, and products of the invention can meet the market requirements. Obviously, the present invention complies with patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A network camera, comprising:
an image sensing unit, for capturing image information;
a digital image processing unit, for converting the image information into a digital video signal;
a serial data encoding unit, for encoding the digital video signal to generate a serial video data signal stream; and
a network control unit, for converting the serial video data signal stream into a serial network signal packet.

2. The network camera of claim 1, further comprising:
an audio sensing unit, for capturing audio information; and
a digital audio processing unit, for converting the audio information into a digital audio signal, wherein the serial data encoding unit encodes the digital video signal and the digital audio signal to generate a serial audio and video signal stream, such that the network control unit converts the serial audio and the video signal stream into a serial audio and video network signal packet.

3. The network camera of claim 1, wherein the digital image processing unit compresses the image information to generate the digital video signal.

4. The network camera of claim 1, wherein the network control unit is connected to at least one data processing device through a cable network or a wireless network.

5. The network camera of claim 4, wherein the data processing device is a computer, a mobile phone or a personal digital assistant (PDA).

6. The network camera of claim 4, wherein the serial data encoding unit integrates a compatible driver program set of the data processing device into the serial data signal.

7. The network camera of claim 4, wherein the cable network or the wireless network is constructed to an intranet.

8. The network camera of claim 4, wherein the data processing device is connected actively to the network control unit through connection software to capture the serial network signal packet.

9. The network camera of claim 1, wherein the serial data encoding unit transmits the serial video data signal stream to the network control unit through a serial data bus.
